(19) United States
(12) Patent Application Publication
(10) Pub. No.: US 2025/0258067 A1
(43) Pub. Date: Aug. 14, 2025

(54) Method for Deparaffinizing Formalin-Fixed, Paraffin-Embedded Tissue

(71) Applicant: DERMAGNOSTIX GMBH, Friedberg (DE)

(72) Inventors: Nils PAUST, Friedberg (DE); Katharina DORMANNS, Friedberg (DE); Franziska SCHLENKER, Friedberg (DE); Lucca WEBER, Friedberg (DE); Stefanie EYERICH, Friedberg (DE); Natalie GARZORZ-STARK, Friedberg (DE)

(73) Assignee: DERMAGNOSTIX GMBH, Friedberg (DE)

(21) Appl. No.: 18/856,944

(22) PCT Filed: Jan. 10, 2023
(86) PCT No.: PCT/DE2023/100009

§ 371 Date: Oct. 15, 2024

(30) Foreign Application Priority Data
May 12, 2022 (DE) 102022111890.8

(51) Int. Cl. G01N 1/30; G01N 1/36; G01N 1/44

(52) U.S. Cl. CPC G01N 1/30; G01N 1/36; G01N 1/44

(57) ABSTRACT

A method for deparaffinizing formalin-fixed, paraffin-embedded tissue (FFPE) in a Centrifugal Microfluidic Biochip with a fluidic system comprising a plurality of chambers, characterized by the steps of: a. placing formalin-fixed, paraffin-embedded tissue (FFPE) into a first chamber of a fluidic system of a Centrifugal Microfluidic Biochip, b. introducing a fluid into the first chamber, c. melting the paraffin by conditioning the first chamber to a temperature above the melting temperature of the paraffin, d. separating the melted paraffin by rotating the Centrifugal Microfluidic Biochip about an axis of rotation, e. solidifying the separated liquid paraffin by conditioning at least a sub-region of the first chamber to a temperature below the melting temperature of the paraffin, and f. discharging the tissue-containing liquid phase depleted of the paraffin from the first chamber.

The invention relates to a process for deparaffinizing formalin-fixed paraffin-embedded tissue (FFPE).

Fixing tissues with formalin and subsequent embedding in paraffin is one of the most common methods for preserving and stabilizing biological tissue used for histological examination. Tumour tissue in particular is predominantly available as formalin-fixed paraffin-embedded material in the context of pathological and oncological examinations, whereby this is also used in the diagnosis of inflammatory diseases or autoimmune diseases.

Although the use of formalin-fixed paraffin-embedded tissue has also proven to be advantageous in histopathology, this type of tissue preservation causes problems in molecular, especially genetic analysis, as the chemical modifications caused by fixation with formalin in particular must first be reversed. To this end, various extraction and renaturation methods have been developed that make formalin-fixed paraffin-embedded tissue (FFPE) accessible for molecular diagnostic procedures even after years of biopsy.

For example, EP 1 825 246 B1 describes a process for deparaffinizing formalin-fixed paraffin-embedded tissue (FFPE), in which the paraffin is transferred to a microemulsion and rinsed off the tissue. EP 2 780 453 B1, on the other hand, describes a process in which the paraffin is removed from the tissue by heating the paraffin and converting it into a lipophilic phase consisting of silicone and wax.

In addition, US 2009/0246782 A1 and KR 101796110 B1 disclose methods for the centrifugal-based processing of biochemical samples in which paraffin is used.

These known methods require a relatively high manual effort or complex equipment set-up to remove the paraffin before the tissue freed of paraffin is accessible for further molecular analysis. In any case, the known methods are largely unsuitable for automatic processing of a sample as part of molecular analyses, including the preparatory measure of deparaffinization.

The object of the invention is therefore to create a method for the molecular analysis of formalin-fixed paraffin-embedded tissue (FFPE), which can be largely automated and can be carried out with little manual effort and with a small apparatus setup.

According to the invention, this object is solved by the method having the features of claim 1. The dependent claims disclose advantageous embodiments of the invention.

The basic idea of the invention is to integrate a process for deparaffinizing formalin-fixed paraffin-embedded tissue (FFPE) in a Centrifugal Microfluidic Biochip, particularly a centrifugal microfluidic bio-disk, in such a way that the steps known per se for analysing the tissue with respect to at least one molecular property can be followed in a manner known per se. The analysis may, for example, relate to the presence, absence or increased or decreased presence of a genetic trait or a protein or a trait at the gene expression level.

By means of a lab-on-a-disk system (Centrifugal Microfluidic Biochip, Centrifugal Microfluidic Bio-Disk or other centrifugal microfluidic test cartridge) designed according to the invention, which combines the preparation and analysis of formalin-fixed paraffin-embedded tissue (FFPE), it is possible to automate labour-intensive and error-prone laboratory routines and to perform various workflows from sample preparation to data analysis in just one step. In particular, a substantially faster analysis of tissue samples and a therapy adapted thereto can be carried out by means of the proposed system.

To enable the highly sensitive diagnosis of molecular markers in FFPE in particular, the paraffin must first be separated from the sample. In particular, paraffin is separated from the tissue block to enable subsequent lysis of the cell components and accessibility of DNA and/or RNA without the need for an additional wax/silicone mixture, a complex lysis reagent with additional components for liquefying paraffin or an ultrasonic unit in the processing device, as proposed in the prior art.

According to the invention, a method for deparaffinizing formalin-fixed paraffin-embedded tissue in a Centrifugal Microfluidic Biochip having a fluidic system comprising a plurality of chambers is thus proposed, comprising the following steps:
a. Placing formalin-fixed, paraffin-embedded tissue (FFPE) into a first chamber of a fluidic system of a Centrifugal Microfluidic Biochip,
b. Introducing a fluid into the first chamber,
c. Melting the paraffin by tempering the first chamber to a temperature above the melting temperature of the paraffin,
d. separating the molten paraffin by rotating the Centrifugal Microfluidic Biochip about an axis of rotation,
e. Allowing the separated liquid paraffin to solidify by tempering at least part of the first chamber to a temperature below the melting temperature of the paraffin, and
f. Discharging the tissue-containing liquid phase depleted of the paraffin from the first chamber.

The Centrifugal Microfluidic Biochip is preferably designed as a centrifugal microfluidic biodisk, i.e. as a disk, with the axis of rotation representing the center of the centrifugal microfluidic biodisk. J In any case, the Centrifugal Microfluidic Biochip will essentially be designed as a cylinder with a base surface, a lateral surface and a top surface. The axis of rotation of the Centrifugal Microfluidic Biochip extends in particular through the height of the Centrifugal Microfluidic Biochip. In particular, the Centrifugal Microfluidic Biochip is designed in such a way that a first chamber is provided which is set up to hold formalin-fixed paraffin-embedded tissue (FFPE).

The fluid used is preferably an aqueous solution, in particular in the form of a buffer. Most preferably, the fluid is a lysis buffer which-adapted to the type of tissue—is suitable for lysing the tissue in order to make the molecules contained in the tissue accessible for molecular biological analysis. This can be a DNA or RNA analysis or a protein analysis. The lysis buffer used can contain buffer salts (e.g. Tris-HCl) and ionic salts (e.g. NaCl) to regulate the pH value and osmolarity of the lysate, as well as detergents (e.g. Triton X-100, SDS or similar). The method according to the invention is most preferably carried out using a lysis buffer which preferably comprises the enzyme Proteinase K, which is used for the degradation of proteins in cell lysates and for the release of nucleic acids.

In any case, the fluid has a density that differs from the density of paraffin, so that the paraffin melted by heat input can be separated due to differences in density. In particular, the fluid has a greater density than liquid paraffin, so that the molten paraffin floats on the fluid surrounding the tissue and possibly lysing it.

It is irrelevant whether the fluid is already present in the first chamber before the formalin-fixed paraffin-embedded tissue (FFPE) is introduced into the first chamber, is introduced into the first chamber together with the formalin-fixed paraffin-embedded tissue (FFPE) or is subsequently introduced into the first chamber. In other words, the order of steps a and b is not decisive, so that step b can also be carried out before step a. The only decisive factor is that a liquid phase is provided which enables the paraffin embedding the tissue to be separated.

The sample in the form of formalin-fixed paraffin-embedded tissue (FFPE) is preferably heated in a first chamber in a lysis buffer/proteinase K mixture, whereby the paraffin is melted. The liquefied paraffin floats on the fluid or most preferably used lysis buffer/proteinase K mixture upon rotation of the biochip due to the difference in density between the lysis buffer and the paraffin on the inside relative to the pivot point. In the liquid phase, in which deparaffinized tissue pieces/particles are present, enzymatic digestion and decrosslinking by proteinase K and lysis buffer take place preferentially. In particular, this enables the transition of the RNA into the liquid phase.

The temperature of the first chamber in step c. and in step e. is preferably controlled by introducing temperature into the Centrifugal Microfluidic Biochip through the base surface of the Centrifugal Microfluidic Biochip and thus through a first chamber wall arranged transverse to the axis of rotation. Particularly preferably, the temperature is applied by means of a heating device provided in a rotary device of a suitable analyzer accommodating the Centrifugal Microfluidic Biochip, the rotary device rotating the Centrifugal Microfluidic Biochip.

The tempering of the first chamber in step c. takes place for a first predetermined time to a temperature of >49° C. and thus to a temperature above the melting point of paraffin. In particular, the first chamber is tempered to a temperature of 55° C. to 65° C.

It is further preferably provided that step c. comprises tempering the first chamber for a second predetermined time to a temperature of between 70° C. and 90° C., which is generated for decrosslinking molecules contained in the tissue.

If the temperature control in step c. and in step e. is carried out by temperature input through a first chamber wall arranged transversely to the axis of rotation, it is further preferably provided that step e. comprises the formation of a temperature gradient extending through the height of the centrifugal microfluidic biochip, the temperature of the first chamber wall through which the temperature input takes place being above the melting point of paraffin and the temperature of a second chamber wall (e.g. the top surface of the centrifugal microfluidic biochip) opposite the first chamber wall (e.g. the base surface of the centrifugal microfluidic biochip) is below the melting point of paraffin. This can particularly preferably be achieved by step e. tempering the first chamber wall to a temperature above the melting point of paraffin, in particular to a temperature of 65° C., whereby the centrifugal microfluidic biochip is rotated about the axis of rotation at a higher frequency than in step d. to cool the second chamber wall below the melting temperature of paraffin.

In principle, however, it is possible to form the temperature gradient in any direction, whereby the geometry of the first chamber must be designed such that the temperature input can be controlled such that the temperature on the first chamber wall corresponds to the melting point of paraffin or is above its melting point and the temperature on the second chamber wall opposite the first chamber wall is below the melting point of paraffin, so that the paraffin can solidify on the second chamber wall.

The separation of the paraffin by partial solidification is preferably achieved by tempering the chamber above the melting point of the paraffin with simultaneous rotation, which is sufficient to create a temperature gradient in the liquid paraffin column (the chamber becomes cooler than the melting point of paraffin on the upper side of the biochip opposite the heating devices due to air turbulence and thus heat dissipation) and the upper part of the column hardens, while the lower part is still liquid.

In particular, it is intended that steps e and f take place at least partially simultaneously. It can also be provided that further processing steps of the tissue are carried out in the first chamber before it is discharged from the first chamber with the liquid phase. The tissue is preferably lysed and suspended in the liquid phase, but can also be discharged with the liquid phase without lysis. The deparaffinization, lysis and decrosslinking of the tissue can therefore be carried out separately in terms of both time and space.

Finally, it is understood that the deparaffinization is to be understood as a preparatory step of a molecular analysis of the tissue, so that a method for the molecular analysis of formalin-fixed paraffin-embedded tissue is also explicitly claimed, which comprises the method according to the invention for deparaffinization, followed by step g. Analyzing the liquid phase containing the lysed tissue with respect to at least one molecular property in a manner known per se.

For the RNA purification of a sample available as formalin-fixed paraffin-embedded tissue (FFPE), the following steps would be exemplary:
1. The sample is heated in a lysis buffer in a first chamber of a Centrifugal Microfluidic Biochip, which melts the paraffin. The paraffin then floats on the lysis buffer as a hydrophobic phase. Enzymatic digestion and decrosslinking take place in the liquid (hydrophilic) phase. This enables the transition of the RNA into the liquid (hydrophilic) phase.
2. Separation by partial solidification is achieved by heating the chamber above the melting point of the paraffin, with simultaneous high rotation, whereby a temperature gradient is created in the liquid paraffin column (chamber becomes cooler at the top than the melting point of paraffin due to air turbulence and thus heat dissipation) and the upper part of the column hardens, while the lower part is still liquid.
3. The paraffin is then separated by solidification of the paraffin.
4. The lysate is discharged and mixed with binding buffer and magnetic particles in another chamber.
5. The magnetic particles are transferred to a third chamber and washed there.
6. Finally, the magnetic particles are transferred to a fourth chamber and the RNA is eluted there, so that the RNA extracted from the formalin-fixed paraffin-embedded tissue (FFPE) is available for further processing as known per se.

The invention is explained in more detail below on the basis of a particularly preferred exemplary embodiment illustrated in the attached drawing.

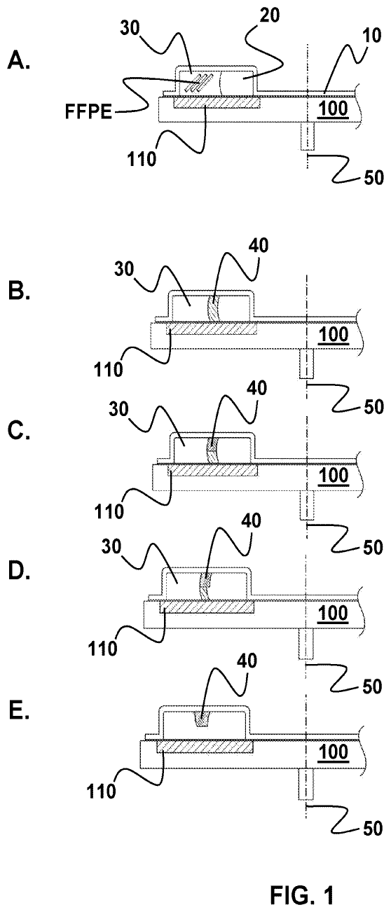

FIG. 1 shows, in particular, the state of an FFPE sample processed in a Centrifugal Microfluidic Biochip during the method steps according to the present invention which proceed sequentially in the example shown. Specifically, FIG. 1A shows a schematic cross section through a Centrifugal Microfluidic Biochip 10 arranged in an analyzer 100. The Centrifugal Microfluidic Biochip 10 is designed as known per se and has a fluidic system, of which a first chamber 20 can be seen in the example shown, in which a formalin-fixed paraffin-embedded tissue FFPE has been introduced, which is surrounded by a fluid 30 which is stored in the Centrifugal Microfluidics biochip 10 and is embodied as a lysis buffer. The buffer 30 can be provided before the introduction of the formalin-fixed paraffin-embedded tissue FFPE in the chamber 20 or can be subsequently added manually from the outside or can be introduced into the first chamber 20 from a further chamber provided in the Centrifugal Microfluidic Biochip 10, in which fluid is kept on hand.

In any case—as shown in FIG. 1B—the paraffin 40 surrounding the tissue is melted by controlling the temperature of the first chamber 20 to a temperature above the melting temperature of the paraffin 40. The temperature is applied by a heating zone 110 provided in the analyzer 100, which causes the temperature to be applied from the base surface of the Centrifugal Microfluidic Biochip 10. When the Centrifugal Microfluidic Biochip 10 is simultaneously rotated about the axis of rotation 50, the liquid paraffin 40 floating on the fluid is separated due to the difference in density between the fluid 30 and the liquid paraffin 40.

If separate phases are present, the separated liquid paraffin 40 is allowed to solidify by tempering at least part of the first chamber 20 to a temperature below the melting temperature of the paraffin 40. In particular, the temperature input into the first chamber 20 is controlled by means of the heating zone 110 of the analyzer 100 in such a way that a temperature gradient is formed by the height of the Centrifugal Microfluidic Biochip 10, which leads to the liquid paraffin 40 solidifying on the cooler wall of the first chamber 20 opposite the heating zone.

In FIG. 1D and FIG. 1E the tissue, being lysed in the meantime, is discharged from the first chamber 20 and is fed to the further processing, wherein the volume of the liquid paraffin 40 decreases and the volume of the paraffin 40 solidified at the wall increases.

1. A method for deparaffinizing formalin-fixed paraffin-embedded tissue (FFPE) in a centrifugal microfluidic biochip having a fluidic system comprising a plurality of chambers, said method comprising:
a. placing formalin-fixed, paraffin-embedded tissue (FFPE) including paraffin into a first chamber of a fluidic system of a centrifugal microfluidic biochip,
b. introducing a fluid into the first chamber,
c. melting the paraffin by tempering the first chamber to a temperature above the melting temperature of the paraffin to produce molten paraffin,
d. separating the molten paraffin by rotating the centrifugal microfluidic biochip about an axis of rotation to produce separated liquid paraffin,
e. allowing the separated liquid paraffin to solidify into solid paraffin by tempering at least part of the first chamber to a temperature below the melting temperature of the paraffin, and
f. discharging the tissue-containing a liquid phase depleted of the paraffin from the first chamber.

2. A method according to claim 1, wherein the fluid is an aqueous solution.

3. A method according to claim 1, wherein the fluid is a buffer.

4. A method according to claim 1, wherein the fluid comprises a proteinase.

5. A method according to claim 4, wherein the proteinase is Proteinase K.

6. A method according to claim 1, wherein step b. comprises introducing the fluid held in the centrifugal microfluidic biochip into the first chamber.

7. A method according to claim 1, wherein the tempering in step c. and in step e. is carried out by applying temperature through a first chamber wall arranged transversely to the axis of rotation.

8. A method according to claim 1, wherein step c. comprises tempering the first chamber to a temperature of >49° C. for a first predetermined time.

9. A method according to claim 8, wherein step c. comprises tempering the first chamber to a temperature of 55° C. to 65° C.

10. A method according to claim 8, wherein step c. comprises tempering the first chamber for a second predetermined time to a temperature of between 70° C. and 90° C. for decrosslinking molecules contained in the tissue.

11. A method according to claim 7, wherein step e. comprises formation of a temperature gradient, the temperature of the first chamber wall through which temperature input takes place being above the melting temperature of paraffin and the temperature of a second chamber wall opposite the first chamber wall being below the melting temperature of paraffin.

12. A method according to claim 11, wherein step e. comprises tempering the first chamber wall to a temperature above the melting temperature of paraffin, the centrifugal microfluidic biochip being rotated about the axis of rotation at a higher frequency than in step d. in order to cool the second chamber wall.

13. A method for molecular analysis of formalin-fixed paraffin-embedded tissue (FFPE), according to claim 1 followed by step g. analyzing the liquid phase containing the tissue with respect to at least one molecular property in a manner known per se.
